(19) United States
(12) Patent Application Publication
(10) Pub. No.: US 2009/0162271 A1
(43) Pub. Date: Jun. 25, 2009

(54) CAVITATION DEVICE AND METHOD

(76) Inventors: William D. Holloway, JR., Phoenix, AZ (US); Michael A. Holloway, Vista, CA (US)

Correspondence Address: LAW OFFICE OF DONALD L. WENSKAY, 16909 VIA DE SANTA FE, 200, P.O. BOX 7206, RANCHO SANTA FE, CA, 92057, US

(21) Appl. No.: 12/106,213

(22) Filed: Apr. 18, 2008

Related U.S. Application Data
(63) Continuation-in-part of application No. 11/831,877, filed on Jul. 31, 2007.
Application No. 11/831,877 is a continuation-in-part of application No. 11/448,602, filed on Jun. 6, 2006, now abandoned.
Application No. 11/448,602 is a continuation-in-part of application No. 11/302,967, filed on Dec. 13, 2005.
Application No. 11/302,967 is a continuation-in-part of application No. 10/420,280, filed on Apr. 21, 2003.
Application No. 10/420,280 is a continuation-in-part of application No. 10/301,416, filed on Nov. 21, 2002.
Application No. 10/301,416 is a continuation-in-part of application No. 09/698,537, filed on Oct. 26, 2000, now Pat. No. 6,521,248.
(60) Provisional application No. 60/820,950, filed on Jul. 31, 2006.
(60) Provisional application No. 60/595,095, filed on Jun. 6, 2005.
(60) Provisional application No. 60/596,170, filed on Sep. 6, 2005.
(60) Provisional application No. 60/780,947, filed on Mar. 8, 2006.
(60) Provisional application No. 60/801,231, filed on May 16, 2006.
(60) Provisional application No. 60/635,915, filed on Dec. 13, 2004.
(60) Provisional application No. 60/596,170, filed on Sep. 6, 2005.
(60) Provisional application No. 60/594,612, filed on Apr. 22, 2005.
(60) Provisional application No. 60/594,540, filed on Apr. 15, 2005.
(60) Provisional application No. 60/161,546, filed on Oct. 26, 1999.

(51) Int. Cl. C01B 5/00; B01J 19/00; C02F 1/34; C02F 1/46

(52) U.S. Cl. 423/580.1; 210/748; 210/243; 210/150

(57) ABSTRACT

A process for modifying a liquid, comprising introducing a liquid into a cavitation device and cavitating the liquid in the cavitation device. During cavitation the liquid makes contact with an electron emitting material to inject electrons into the liquid. In some embodiments, the electron emitting material is a quartz crystal and the cavitation process produces micro-clustered water.

### RELATED APPLICATIONS

This application is a continuation-in-part of application Ser. No. 11/831,877, filed on Jul. 31, 2007, which claims priority to provisional application No. 60/820,950, filed Jul. 31, 2006, and is a continuation-in-part of application Ser. No. 11/448,602, filed Jun. 6, 2006, which claims priority to each of provisional applications No. 60/595,095, filed Jun. 6, 2005, No. 60/596,170, filed Sep. 6, 2005, No. 60/780,947, filed Mar. 8, 2006, and No. 60/801,231, filed May 16, 2006, and which is a continuation-in-part of application Ser. No. 11/302,967, filed Dec. 13, 2005, which claims the priority to provisional applications No. 60/635,915, filed Dec. 13, 2004, No. 60/596,170, filed Sep. 6, 2005, No. 60/594,612, filed Apr. 22, 2005 and No. 60/594,540, filed Apr. 15, 2005, and which is a continuation-in-part of Ser. No. 10/420,280, filed Apr. 21, 2003; which is a continuation-in-part of application Ser. No. 10/301,416, filed Nov. 21, 2002, which is a continuation-in-part of application Ser. No. 09/698,537, filed Oct. 26, 2000, now issued as U.S. Pat. No. 6,521,248, which claims priority to provisional application No. 60/161,546, filed Oct. 26, 1999.

Each of the above-identified applications is incorporated by reference in its entirety and for all purposes.

### FIELD OF THE INVENTION

The invention relates generally to controllably modifying a liquid using cavitation and in particular, the invention relates to the introduction of electrons to a liquid undergoing cavitation.

### BACKGROUND OF THE INVENTION

Water is composed of individual H₂O molecules that may bond with each other through hydrogen bonding to form clusters that have been characterized as five species: unbonded molecules, tetrahedral hydrogen bonded molecules comprised of five (5) H₂O molecules in a quasi-tetrahedral arrangement and surface connected molecules connected to the clusters by 1, 2 or 3 hydrogen bonds. These clusters can then form larger arrays consisting of varying amounts of these micro-cluster molecules with weak long distance van der Waals attraction forces holding the arrays together by one or more of such forces as; (1) dipole-dipole interaction, i.e., electrostatic attraction between two molecules with permanent dipole moments; (2) dipole-induced dipole interactions in which the dipole of one molecule polarizes a neighboring molecule; and (3) dispersion forces arising because of small instantaneous dipoles in atoms. Under normal conditions the tetrahedral micro-clusters are unstable and reform into larger arrays from agitation, which impart London Forces to overcome the van der Waals repulsion forces. Dispersive forces arise from the relative position and motion of two water molecules when these molecules approach one another and results in a distortion of their individual envelopes of intra-atomic molecular orbital configurations. Each molecule resists this distortion, resulting in an increased force opposing the continued distortion, until a point of proximity is reached where London Inductive Forces come into effect. If the velocities of these molecules are sufficiently high enough to allow them to approach one another at a distance equal to van der Waals radii, the water molecules combine.

As described in the aforementioned incorporated-by-reference patents and patent applications, liquids (e.g. water), which may form large molecular through various electrostatic and van der Waal forces (e.g., water), can be disrupted through cavitation into fractionated or micro-cluster molecules (e.g., theoretical tetrahedral micro-clusters of water). Also disclosed are methods for stabilizing newly created micro-clusters of water by utilizing van der Waals repulsion forces. The method involves cooling the micro-cluster water to a desired density, wherein the micro-cluster water may then be oxygenated. The micro-cluster water is bottled while still cold. In addition, by overfilling the bottle and capping while the micro-cluster oxygenated water is dense (i.e., cold), the London forces are slowed down by reducing the agitation which might occur in a partially filled bottle while providing a partial pressure to the dissolved gases (e.g., oxygen) in solution thereby stabilizing the micro-clusters for about 6 to 9 months when stored at 40 to 70 degrees Fahrenheit.

A number of beneficial uses of micro-clusters of water have been found in the areas such as medicine, chemical processes, nutraceuticals, cosmaceutical, and others. There is growing scientific evidence that many of these benefits may, in part, be due to the presence of free electrons in the micro-clustered water. Hence there is currently a need for a process whereby large molecular arrays of liquids can be advantageously fractionated to produce smaller molecular (e.g., micro-clusters) of water with an increased number of free electrons.

### SUMMARY OF THE INVENTION

To overcome the limitations in the prior art briefly described above, the present invention provides a method and system for introducing electrons into a liquid during cavitation.

In one aspect of the invention, a process for modifying a liquid comprises: introducing a liquid into a cavitation device; cavitating the liquid in the cavitation device; and causing the liquid to make contact with an electron emitting material during the cavitating.

In another aspect of the invention, a method for producing a micro-clustered liquid comprises cavitating a liquid, and adding electrons to the liquid during the cavitation.

In another aspect of the invention, an apparatus for processing a liquid comprises a cavitation device having a cavitation chamber, and an electron emitting component within the cavitation chamber.

In one embodiment of the invention, a system for producing a micro-cluster liquid from a starting liquid comprises: a housing; a chamber disposed within the housing; an electron emitting element disposed within the chamber; and a plurality of volutes disposed within the housing for receiving a liquid and establishing a rotational vortex for spinning the liquid and directing the liquid radially onto the electron emitting element.

Various advantages and features of novelty, which characterize the present invention, are pointed out with particularity in the claims annexed hereto and form a part hereof. However, for a better understanding of the invention and its advantages, reference should be made to the accompanying descriptive matter together with the corresponding drawings which form a further part hereof, in which there are described and illustrated specific examples in accordance with the present invention.

### BRIEF DESCRIPTION OF THE DRAWINGS

FIG. 1 shows a water molecule and the resulting net dipole moment.

FIG. 2 shows a large array of water molecules.

FIG. 3 shows a micro-cluster of water having five water molecules forming a tetrahedral shape.

FIG. 4 is a diagrammatic top view of a device for creating cavitation.

FIG. 5A shows FTIR spectra for reverse osmosis water.

FIG. 5B shows FTIR spectra for micro-cluster water according to the present invention.

FIG. 6 shows TGA plots for two types of water.

FIGS. 7A, 7B and 7C show NMR spectra for three types of water where: FIG. 7A shows the spectra for distilled water; FIG. 7B shows the spectra for micro-cluster water with no added oxygen; and FIG. 7C shows the spectra for micro-cluster water with oxygen added.

FIG. 8 is a flow diagram of the main steps in a process for making micro-cluster water.

FIG. 9 is a flow diagram of a preferred pre-processing technique for cleaning typical city water to prepare the water for creation of micro-clusters.

FIG. 10A is a cross-sectional view of one embodiment of a cluster fractioning unit taken along line 10A-10A of FIG. 10B.

FIG. 10B is a cross-sectional view of the cluster fractioning unit taken along line 10B-10B of FIG. 10A.

FIGS. 11A-D show views of an embodiment of a cluster fractioning module, where: FIG. 11A is a top view of the module; FIG. 11B is a side view of the bottom part of the module; and FIGS. 11C and 11D are inside surface and side views, respectively, of the module lid.

FIGS. 12A-12H show views of the fractioning nozzle and its parts, where: FIG. 12A is a side view of an assembled nozzle; FIG. 12B is a side view of the bottom part of the nozzle; FIG. 12C is a cross-sectional view of the bottom part taken along line 12C-12C of FIG. 12B; FIG. 12D is a cross-sectional view of the bottom part of the nozzle taken along line 12D-12D of FIG. 12C; FIG. 12E is a side view of the top part of the nozzle; FIG. 12F is a cross-sectional view taken along line 12F-12F of FIG. 12E; FIG. 12G is a cross-sectional view taken along line 12G-12G of FIG. 12F; and FIG. 12H is a size view of the assembled nozzle showing the interior features in dashed lines.

FIGS. 13A and B show an alternate embodiment of a cluster fractioning module using piezoelectric drivers to create cavitation, where FIG. 13A is a top view of the module with one mounting plate removed; and FIG. 13B is a side view of the module.

FIG. 14 shows a system for testing properties of micro-cluster water against other water.

FIGS. 15A-15C show an alternate nozzle embodiment having five nozzles in a two piece assembly where: FIG. 15A shows the bottom section of the nozzle assembly; FIG. 15B shows the top section of the nozzle assembly; and FIG. 15C is a side view of the top and bottom sections assembled.

FIG. 16 shows an alternate nozzle assembly having five nozzles distributed radially.

FIG. 17 is a front elevation of a preferred embodiment of the cavitation device showing the placement of the nozzles within the housing.

FIG. 18 is a diagrammatic view of a system for mixing incorporating the cavitation device.

FIG. 19 is an exploded side elevation of a nozzle for use in the inventive device.

FIG. 20 is an entrance face view of the front section of the nozzle of FIG. 19.

FIG. 21 is an interior face view of the back section of the nozzle of FIG. 19.

FIG. 22 is an entrance face view of the vacuum plate of the nozzle of FIG. 19.

FIG. 23 is a diagrammatic view of the exit orifice of the nozzle showing the spray pattern of the exiting liquid.

FIG. 24 is a diagrammatic top view of an alternate embodiment of the device with two sets of nozzles.

### DESCRIPTION OF THE PREFERRED EMBODIMENTS

The present invention relates to a device and method for processing liquids, including water, which induce and exploit the formation, implosion and explosion of numerous cavitation bubbles to introduce free electrons into the liquid. Substantial chemistry is caused within some of these cavitation bubbles, causing them, in a sense, to become minute reaction chambers. These reaction chambers are formed, filled with reactants and collapse within a short time frame, perhaps micro- to picoseconds, or even femtoseconds. During the implosion of these bubbles, intense pressures and temperatures are reached, thereby accelerating the chemical reaction. Although the temperatures and pressures are extreme, they are transient and short in duration as they are rapidly dispersed by the water (or other liquid) in which they occur. The cavitation reaction chambers form because of the fluid-flow mechanics within the device. As described above, acoustical energy released by such cavitation can breaking up large molecules into smaller micro-clusters of molecules. Liquids having micro-cluster molecules have been found to have a number of benefits.

Some of the beneficial effects of micro-clustered liquids, particularly micro-clustered water are generally thought to result from an increase in the number of free electrons in the micro-clustered water. For instance, such free electrons may have an antioxidant effect. The present invention provides a way to further increase the number of free electrons in micro-clustered water by using the cavitation process to facilitate the removal of electrons from a material introduced into the cavitation device.

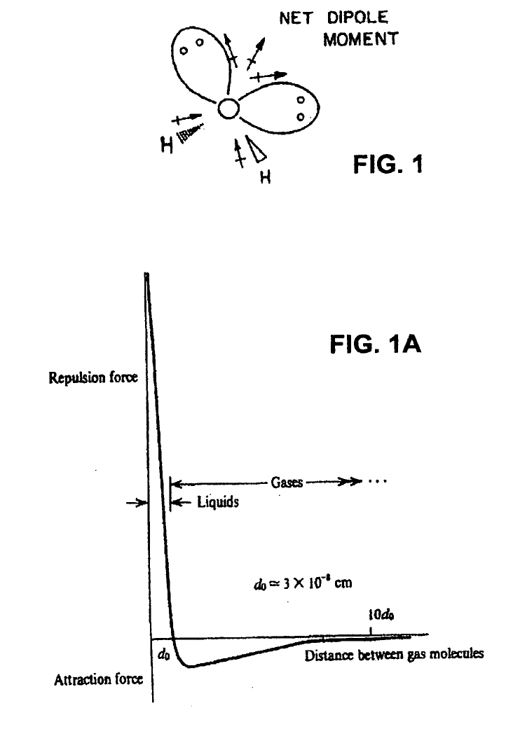

For a fuller understanding of the effects of cavitation in a liquid, reference is made to FIG. 1A, which is a graph showing the repulsive and attractive forces, discussed above, as a function of distance between the molecules. For liquids, the average spacing between simple molecules at normal pressures and temperatures is of the order of do, the distance at which the net forces, both attractive and repulsive, is zero. For gases, the spacing is on the order of 10d₀. When the groups are brought closer than their van der Waals radii (d₀ in FIG. 1A), the force between them becomes repulsive because their electron clouds begin to interpenetrate each other.

Numerous liquids can be processed using the techniques described herein. Liquids are molecules comprising one or more basic elements or atoms. In the case of water, the molecules are hydrogen and oxygen. The interaction of the atoms through covalent bonds and molecular charges form molecules. A molecule of water has an angular or bent geometry. The H—O—H bond angle in a molecule of water is 104.5 degrees as depicted in FIG. 1. This configuration creates electrostatic forces that allow for the attraction of other molecules of water.

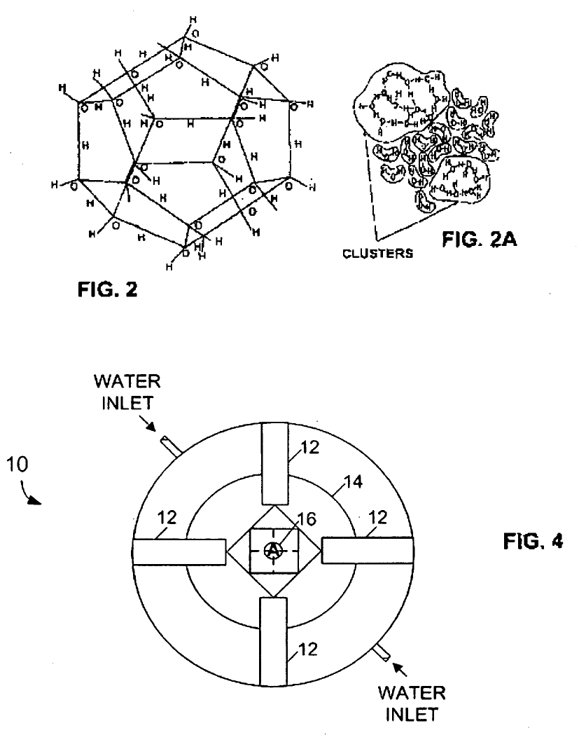

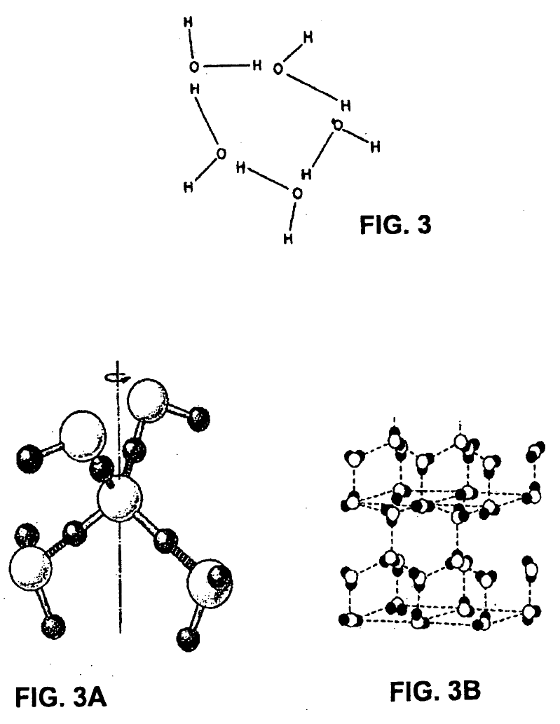

Studies by Pugliano et al., (Science, 257:1937, 1992) have suggested the relationship and complex interactions of water molecules preferably at four locations as indicated in FIG. 1. This can result in a five-molecule water structure as shown in FIGS. 3A and 3B. This five-molecule cluster is a natural molecular configuration of frozen water (ice), but water clusters tend to be much larger, as shown in FIGS. 2 and 2A. An objective of the inventive process and device is to produce water with a substantially increased number of five molecule clusters, hence the name of the water, “Penta® Water”.

Hydrogen bonding and oxygen-oxygen interactions play a major role in creating large clusters of water molecules. Substantially purified water forms complex structures comprising multiple water molecules each interacting with an adjacent water molecule (as depicted in FIG. 2 and FIG. 2A) to form large clusters. These large clusters are formed based upon, for example, non-covalent interactions such as hydrogen bonds and as a result of the dipole moment of the molecule. These large molecules have been suggested to be detrimental in various chemical and biological reactions. Accordingly, in one application of the inventive device, a method of forming fractionized or micro-cluster water molecules having 2 to 5 molecules of H₂O water is provided. The five-molecule cluster is depicted in FIGS. 3 and 3A.

One technique for creating micro-cluster water is cavitation. Any number of techniques known to those of skill in the art can be used to create cavitation in a fluid so long as the cavitating source is suitable to generate sufficient acoustic energy to break the large arrays. The acoustic energy produced by the cavitation provides energy to break the large fluid arrays into smaller fluid clusters. For example, acoustical transducers may be utilized to provide the required cavitation source. In addition, a fluid may be forced through a tube having a constriction in its length providing for a high pressure before the constriction, which is rapidly depressurized within the constriction and then pressurized again after the restriction. Another example includes forcing a fluid in reverse direction through a volumetric pump.

In one embodiment, water to be fractionized is pressurized into a rotational volute to create a vortex that reaches partial vacuum pressures creating cavitation bubbles in the vortex. The water then exits at or close to atmospheric pressure to implode the bubbles. This pressurization, sudden decompression and compression again of the water causes the creation and implosion of cavitation bubbles that create acoustical energy shockwaves. The shockwaves break the bonds on large fluid clusters, breaking the weak array bonds to form micro-cluster or fractionized fluid. The resulting fluid consists of, for example, about five H₂O molecules in a quasi tetrahedral arrangement (as depicted in FIGS. 3 and 3A). The micro-cluster water is recycled through the fractionizing process until the desired number of micro-cluster water molecules are formed, as determined by the temperature rise of the fluid over time as cavitation bubbles impart kinetic heat to the processed fluid. Preferably, that temperature is about 140° F. Once the desired conditions are reached, the micro-cluster fluid is cooled. (The desired conditions can be measured in any number of ways but are preferably detected by temperature.) The fluid is cooled slowly. Once the fluid reaches a desired lower temperature, typically at about 4° to 15° C., molecular oxygen is introduced to attain the desired quantity of oxygen in the micro-cluster fluid. The micro-cluster fluid is then preferably dispensed into containers, such as bottles, which are filled to maximum capacity and capped while the oxygenated micro-cluster water is still cool, thus applying a partial pressure to the oxygenated micro-cluster water when the temperature of the water reaches room temperature. This enables larger quantities of dissolved oxygen to be maintained in solution due to increased partial pressure on the bottle's contents.

The present invention provides a method for making a micro-cluster or fractionized liquid and for adding free electrons to the liquid. For ease of explanation, water will be used as the example; however any type fluid may be substituted for water. A starting water such as, for example, purified or distilled water is used as a base material since it is relatively free of mineral content. The water is then placed into a food grade stainless steel tank for processing. The starting water is passed through a pump capable of supplying a continuous pressure of between about 55 and 120 psig or higher to create a continuous stream of water. This stream of water is then introduced into cavitation nozzle configurations capable of establishing a multiple rotational vortex reaching partial vacuum pressures of about minus 12 psig, thereby reaching the vapor pressure of water and of dissolved entrained gases in the water. The cluster fractioning units can have four opposing vortex volutes with a 6-degree acceleration tube exiting into a common chamber at or close to atmospheric pressure, providing less than 5 psig backpressure. The gases and water vapor form cavitation bubbles that travel down multiple acceleration tubes and exit into a common chamber at or close to atmospheric pressure, causing the cavitation bubbles to implode or explode. The resultant shock waves produced by the imploding and exploding cavitation bubbles provides the energy for additional and useful chemistry to happen. Very high temperatures are created at a sub-micron level but the surrounding water rapidly absorbs the heat. In preferred embodiments, the water is repeatedly circulated through the cavitation nozzles until the water temperature has risen from about 77° F. to about 140° F. A similar dissipation of heat occurs where another liquid, say oil, is subjected to the process.

It will be recognized by those skilled in the art that the water produced in accordance with the present invention can be further modified in any number of ways. For example, following formation of the micro-cluster water, the water may be oxygenated as described herein, further purified, flavored, distilled, irradiated, and any number of further modifications known in the art and which will become apparent depending on the final use of the water.

In a first method for processing a fluid to produce a micro-cluster fluid, about 325 gallons of steam-distilled water from Culligan® Water in 5 gallon bottles at a temperature about 29° C. ambient temperature were placed in a 316 stainless steel non-pressurized tank with a removable top for treatment. The tank was connected by a bottom feed 2¼″ 316 stainless steel pipe that is reduced to 1″ NPT into a 20″ U.S. Filter housing containing a 5 micron fiber filter. The filter serves to remove contaminants that may be in the water. Output of the 20″ filter is connected to a Teel model 1V458 316 20 stainless steel Gear pump driven by a 3HP 1740 RPM three-phase electric motor by direct drive. At the output of the gear pump, 1″ NPT was directed to a cavitation device via 1″ 316 stainless steel pipe fitted with a 1″ stainless steel ball valve, used for isolation only, and past a pressure gauge. The output of the pump delivers a continuous pressure of 65 psig to the cavitation device.

The cavitation device 10, illustrated in FIG. 4, is composed of four small inverted pump volutes 12 made of Teflon® (polytetrafluoroethylene) without impellers, housed in a 316 stainless steel pipe housing 14. The volutes 12 are tangentially fed water by a pair of water inlets 18. A quartz crystal rod 16 is placed at the center of the steel pipe housing 14.

The water inlets 18 are fed by the 1V458 Gear pump (not shown) at 65 psig through a ¼″ hole that, although normally used as the discharge of a pump, is utilized as the input for the purpose of establishing a rotational vortex. The water entering the four volutes 12 is directed in a circle 360 degrees and discharged by the means of a 1″ long acceleration tube (not shown) with a ⅜″ discharge hole (not shown). The discharge hole would normally be the suction side of a pump volute but, in this case, is utilized as the discharge side of the device. The four reverse fed volutes 12 establish rotational vortexes that spin the water through one 360 degree rotation, then discharge the water down the four acceleration tubes, each of which provides a 6 degree decreasing angle (as measured from the center line of the tube) acceleration section.

The water flowing out of the volutes 12 impinges the crystal rod 16, which releases electrons into the water in the presence of the cavitating water. As discussed below, other materials and techniques may be used besides the crystal rod 16 as a source of free electrons. The accelerated water containing the extra electrons is then discharged into a common chamber at or close to atmospheric pressure. The common chamber is connected to a 1″ stainless steel discharge line that feeds back into the top of a 325-gallon tank containing the distilled water. At this point, the water has made one treatment pass through the device. The process described above may be repeated continuously until the energy created by the implosions and explosions of the cavitation (e.g., due to the acoustical energy) have imparted sufficient kinetic heat to the water to raise the water temperature to about 60 degrees Celsius.

Although they are under no obligation to explain the theory of the invention and are not to be bound by this explanation, the inventors believe that the acoustical energy created by the cavitation breaks the static electric bonds tetrahedral micro-clusters of five H₂O molecules together in larger clusters, thus decreasing the size of the clusters. Further, the inventors believe that the acoustical energy also strips electrons from the surface of the crystal rod.

A hand held infrared thermal detector through a stainless steel thermo well was used to detect the temperature of the water. Those of skill in the art will recognize that there are other methods of assessing the temperature. Once the temperature of 60° C. has been reached, the pump motor is secured and the water is left to cool. An 8-foot by 8-foot insulated room fitted with a 5,000 Btu air conditioner is used to expedite cooling, but this is optional. During cooling, the processed water should not be agitated, and should be moved as little as possible.

A target cooling temperature of 4° C. can be used; however, 15° C. is sufficient. The target cooling temperature will vary depending upon the quantity of water being cooled. Once sufficiently cooled to about 4° to 15° C., the water can be oxygenated. After cooling, the processed water is transferred from the 325-gallon stainless steel tank into 5-gallon polycarbonate bottles for oxygenation. Oxygenation is accomplished by applying oxygen gas at a pressure of 20 psig input through a ¼″ ID plastic line fitted with a plastic air diffuser utilized to make fine air bubbles (e.g., Lee's Catalog number 12522). The plastic tube is run through a screw-on lid on the 5-gallon bottle until it reaches the bottom of the bottle. The line is fitted with the air diffuser at its discharge end. The oxygen is applied at 20 psig flow pressure to insure a good visual flow of oxygen bubbles. In one embodiment (Oxy-Hydrate), the water is oxygenated for about five minutes. In another embodiment (Oxy-Hydrate Pro), the water is oxygenated for about ten minutes.

Immediately after oxygenation, the water is bottled in 500 ml PET (polyethylene terephthalate) bottles, filled to overflowing and capped with a pressure seal type plastic cap with inserted seal gasket. In one embodiment, the 0.5 liter bottle is over-filled so that when the temperature of the water increases to room temperature it will self pressurize the bottle, retaining a greater concentration of dissolved oxygen at partial pressure. This step not only keeps more oxygen in a dissolved state, but also helps minimize agitation of the water during shipping.

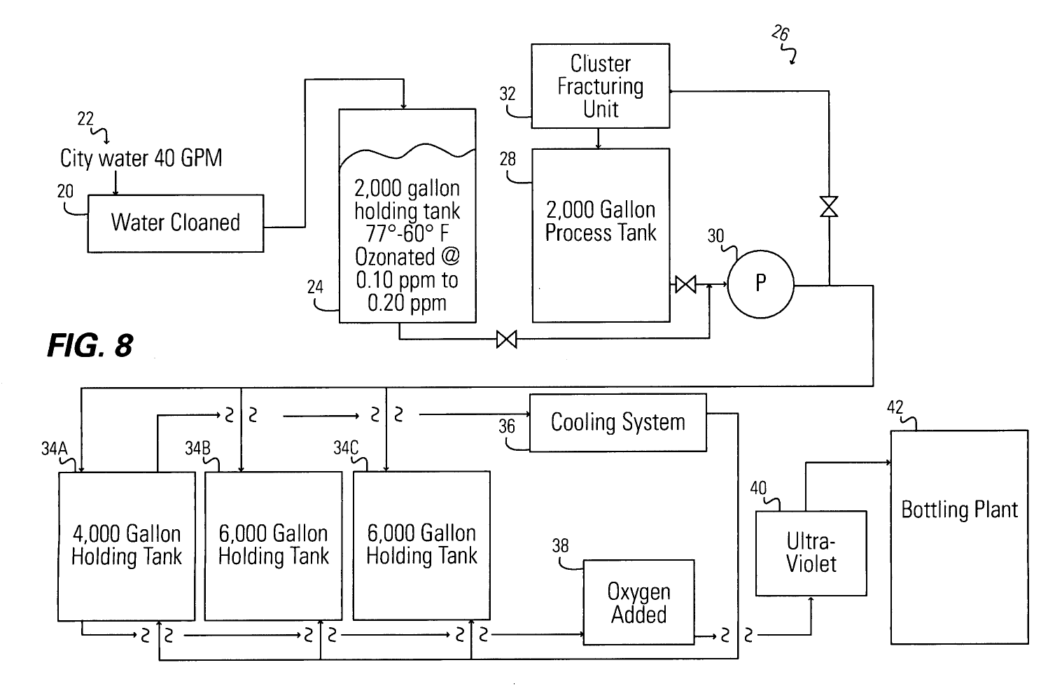

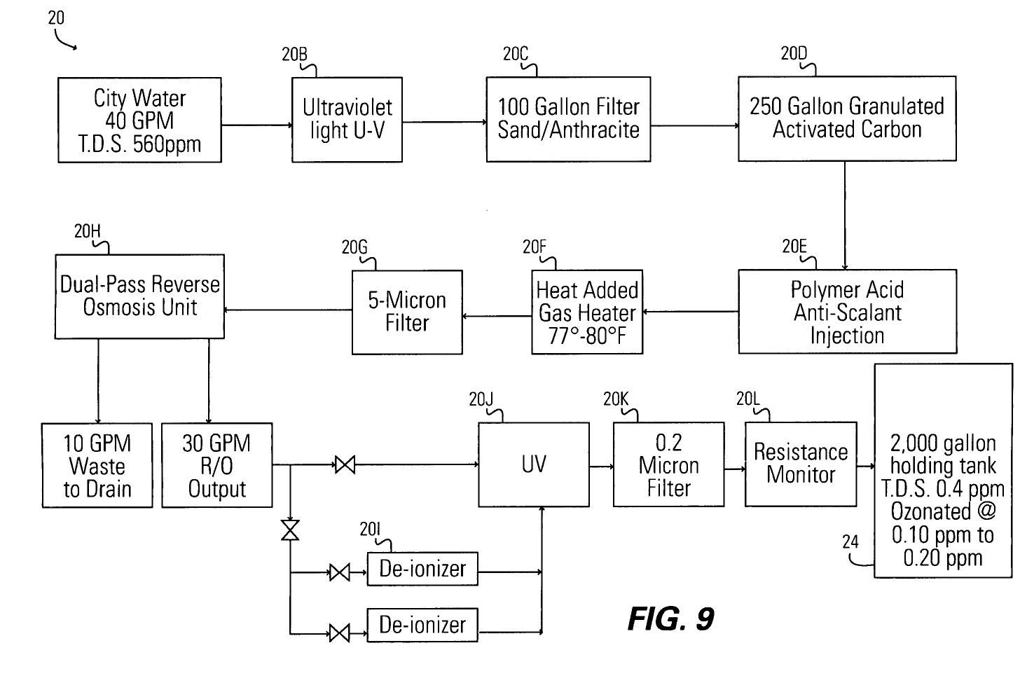

A second preferred process and device for making micro-cluster water are shown in FIGS. 8-12. FIGS. 8 and 9 show summary block diagrams of the entire process. City water 22 at a flow rate of 40 GPM is processed through a set of initial processing equipment 20 to reduce the total dissolved solids in the water from about 450 ppm to a level of about 0.4 ppm. FIG. 9 shows a flow diagram of a preferred pre-processing technique 20 for cleaning typical city water to prepare the water for creation of micro-clusters. In particular, pre-processing 20 may include conventional filtering techniques utilizing UV light 20A, sand/anthracite filtering 20C, carbon filtering 20D, polymer acid 20E, heat 20F, 5-micron filtering 20G, reverse osmosis 20H, de-ionizers 201, further UV 20J, 0.2 micron filtering 20K, and resistance monitoring 20L. This pre-processing 20 results in a sewer discharge of about 25 percent of the incoming water, leaving a net flow rate of about 30 GPM. This initial processing 20 continues until a 2000 gallon holding tank 24 is filled.

Referring now to FIG. 8, the water in tank 24 is treated with ozone to maintain an ozone level of 0.10 ppm to 0.20 ppm until the water is ready to be processed in a cluster fracturing system 26. System 26 includes process tank 28, pump 30 and cluster fracturing unit 32. After the 2000-gallon batch has been processed through system 26, the water temperature is about 140° F. The water is then pumped into one of three holding tanks 34A, 34B or 34C, and is then cooled by a cooling system 36 to a temperature of 55° F. Oxygen is then added by an oxygenator 38. The water is treated with ultraviolet light 40, and then is transferred into water bottles at bottling plant 42.

### Cavitation System

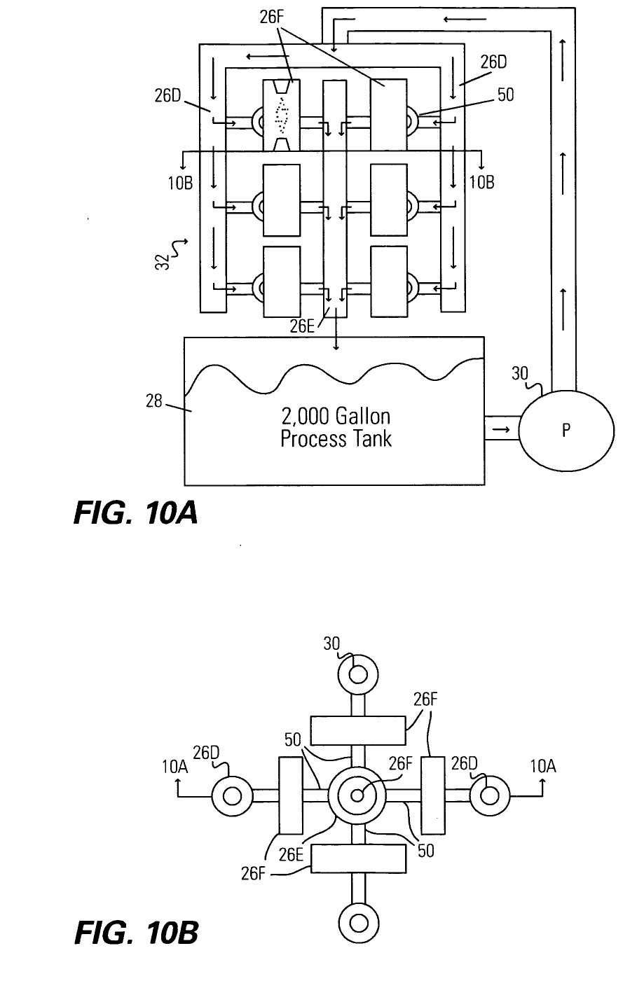

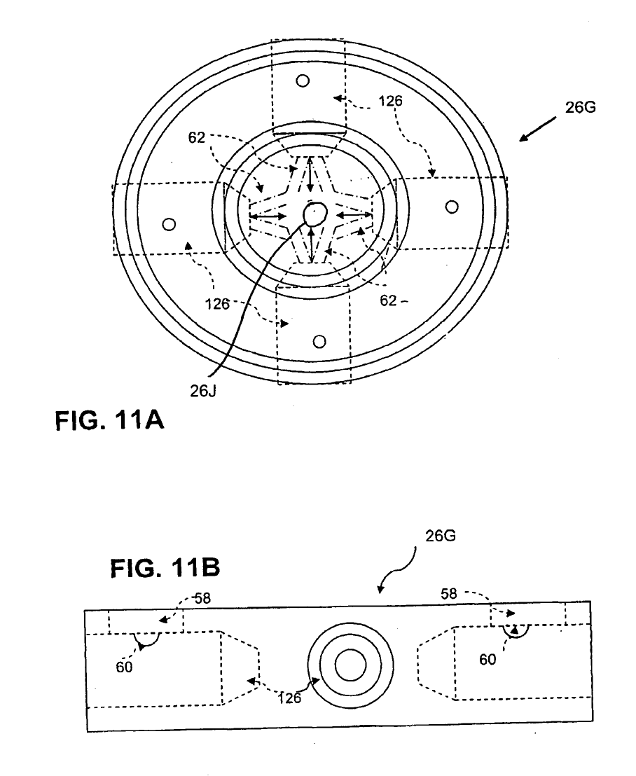

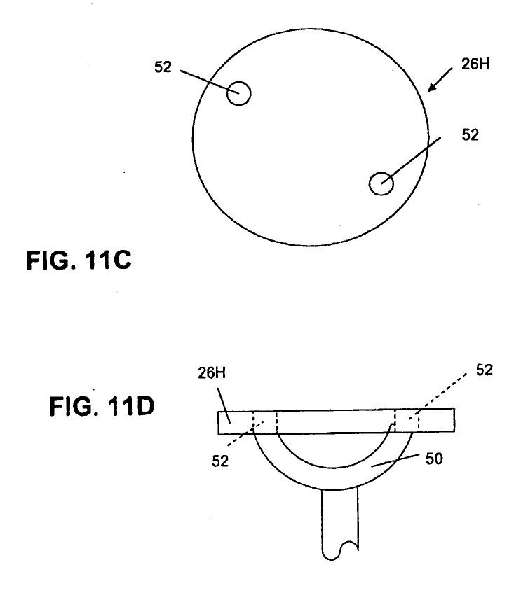

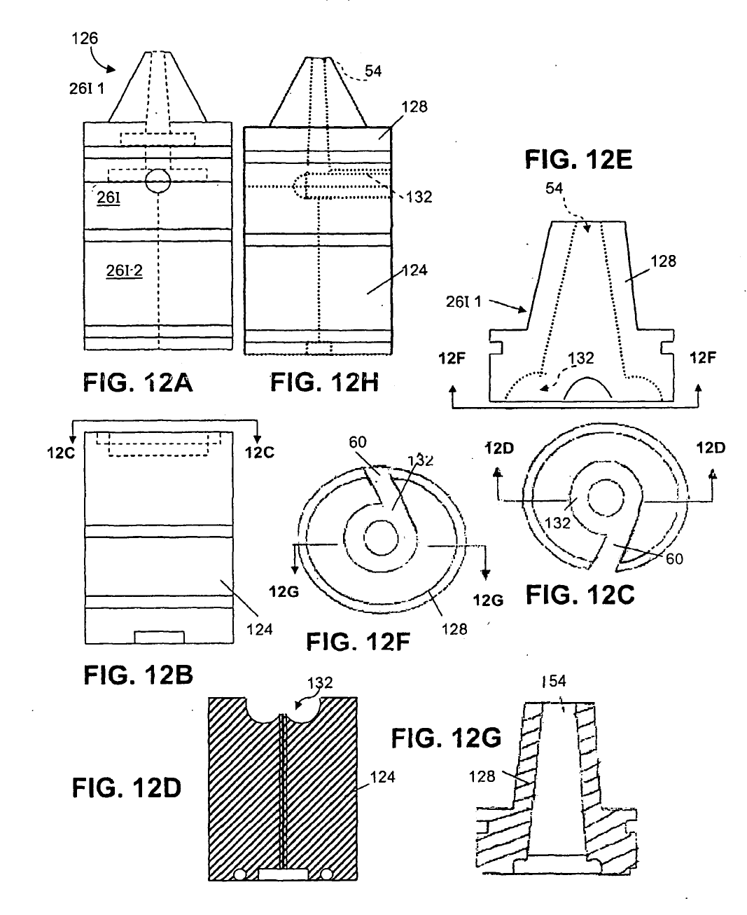

The components of cluster fracturing system 26 are shown in FIGS. 10A through 12G. FIG. 10A shows a side cross-sectional view of the system 26 and FIG. 10B shows a top cross-sectional view of a portion of the system 26 as indicated by the view indicators on the two figures. Referring briefly back to FIG. 8, water is pumped into tank 28 from tank 24 using pump 30 until tank 24 is empty. Pump 30 then re-circulates the water at 400 GPM for about 7 to 8 hours until the water temperature has reached 140° F. Over this period, the water makes about 90 passes through the cluster fractioning unit 32. As illustrated in FIGS. 10A and 10B, cluster fractioning unit 32 comprises input manifolds 26D, central drain 26E, twelve cluster fracturing modules 26F, and crystal rod 26J. Each cluster fracturing module 26F comprises a stainless steel base 26G, as shown in FIGS. 11A and 11B, and a stainless steel lid 26H as shown in FIGS. 11C and 11D. Each cluster fractioning module 26F also includes four nozzles 126, which may be made of Delron® supplied by Dow Chemical. FIGS. 12A-12H illustrate details of the nozzle. The nozzle 126 is formed in two parts that are separable and labeled 26l 1 26l 2 in FIG. 12A. The top part 128 of the nozzle 126, i.e., the part from which the liquid exits, is shown in FIGS. 12A, D, E, F, G and H. The bottom part 124 of nozzle 126 is shown in FIGS. 12A, B and C.

Referring again to FIG. 10A, as well as FIGS. 11C and 11D, in operation, water is pumped by pump 30 at 400 GPM at a head pressure of 120 psig through input manifolds 26D and y-shaped input tubes 50, which are welded at the holes 52 in the lid 26H of modules 26F. The water pressurizes a ¼ inch deep space 58 between the top and base of modules 26F. From space 58, the water is forced through a volute-type cavity 60 in nozzle 126, where it is forced into a helical path 132 accelerating and traveling helically through nozzle 26 and out the nozzle opening 54. Water exits each of the four nozzles 126 in each module 26F in a circulating fan-shaped pattern 62 so that the exiting water collides with water exiting the adjacently located nozzles 126 as shown in FIG. 11A. Water exiting each nozzle 126 also collides with the crystal 26J, causing the crystal to release free electrons into the water. Rapid decompression near the centerline inside the nozzle creates cavitation bubbles, which immediately collapse when they encounter higher pressures in the nozzle and when exiting the nozzle. The collapse of the bubbles create cavitations (with extremely high temperatures and pressures) producing microscopic explosions with pressure waves having tremendous localized forces sufficient to break up large molecular structures in the water and creating microstructures.

A third process for making micro-cluster water is similar to that described for the second process except for the cluster fractioning technique. In this case, piezoelectric drivers create cavitation bubbles in the water which quickly collapse under the water pressure to generate shock waves similar to the ones created in the vortex unit of the second process. The following piezoelectric ultrasonic equipment is preferred for creating the cavitation effects:

4 Branson Ultrasonics 2000b/bdc power supplies

4 Branson Ultrasonic CR Converters pn 101-1350060

4Branson Ultrasonic Hi-Gain Horns 2 inch dia, titanium pn 316-017-021

4 Branson Ultrasonic Solid mount Boosters, silver, amplitude radio 1:2 pn 101-149-098

4Branson Ultrasonics J911 15 foot start cable

1 four-way feed through cross 316L stainless steel ultrasonic cavitation chamber specially manufactured.

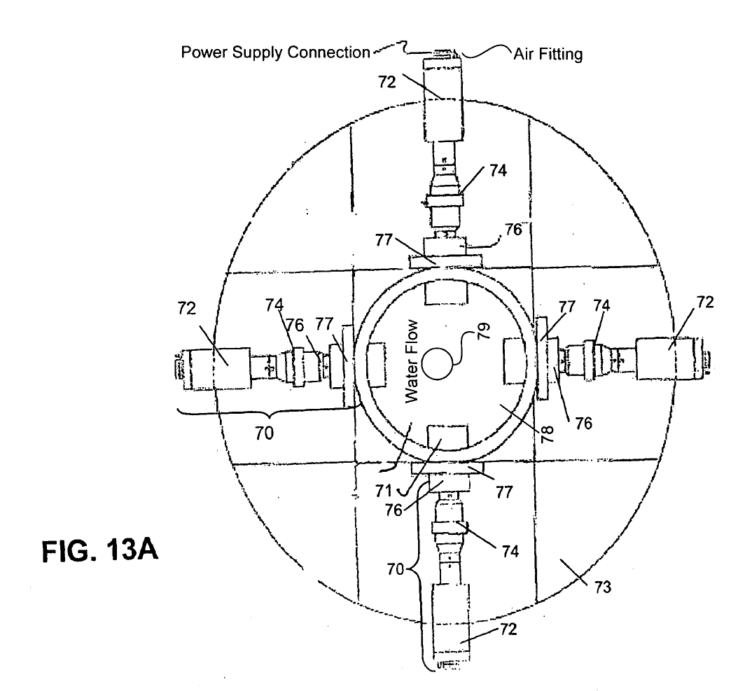

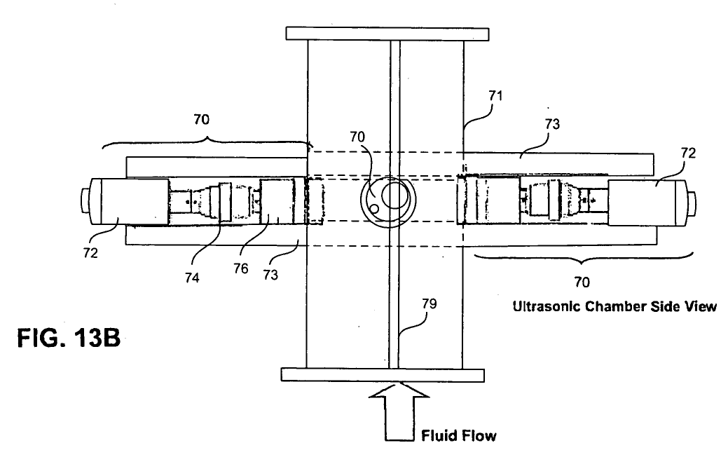

The ultrasonic cavitation chamber of this embodiment is shown in FIG. 13A (end view) and FIG. 13B (side view). The chamber is made from 4″ 316L stainless steel sanitary tubing equipped with Tri-Clover sanitary tube clamps. The Ultrasonic cavitation chamber consists of a 4″ six-way stainless steel tubing cross 71 for the mounting of the four Branson ultrasonic transducers assemblies 70 each consisting of a CR Converter 72 part number 101-1350060, Amplitude Booster 74 part number 101-149-098 and Hi-gain Horn 76 part number 316-017-021 and a 4″ water/liquid feed through connection for the water/fluid under treatment to pass through the ultrasonic cavitation chamber 78. Crystal rod 79 is located at the center of chamber 78. The cavitation produced by the transducer assemblies 70 strips electrons off the crystal 79, whereupon they enter the fluid passing through the ultrasonic cavitation chamber. Crystal rod 79 may comprise a quartz crystal, or other crystal, or other materials, such as a semiconductor, capable of providing electrons to the fluid in the presence of cavitation.

The flow direction is 90 degrees from the four Branson ultrasonic transducer assemblies 70. Transducer assemblies 70 are mounted between support plates 73 and attached in accordance with Branson mounting instructions provided with the transducer assemblies. Horns 76 are mounted in the four 90 degree cross connections by Tri-Clover sanitary tubing clamps and made water tight by means of O-rings 77 mounted at the nodal point of the horn to limit wear and allow for maximum ultrasonic movement of the transducer horn.

Another embodiment of the present invention (not shown) comprises a scaled up water treatment system utilizing both ultrasonic cavitation and vortex induced cavitation combined as described in second and third methods to increase efficiency for large scale volume.

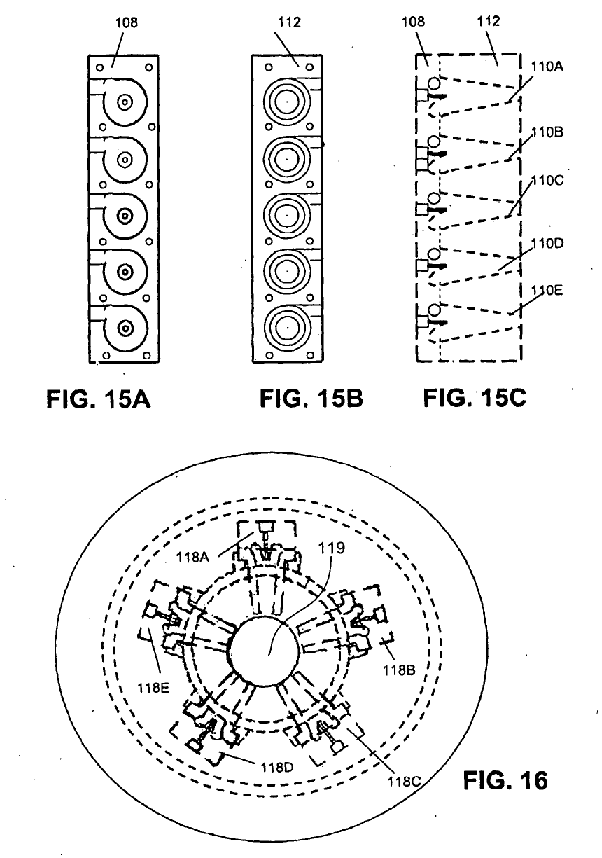

Another embodiment of the cavitation device is a 5-nozzle version, shown in FIGS. 15A-C. As shown in FIGS. 15A-15C, the nozzle assembly has five nozzles in a two piece assembly, where FIG. 15A shows the bottom section of the nozzle assembly; FIG. 15B shows the top section of the nozzle assembly; and FIG. 15C is a side view of the top and bottom sections assembled.

FIG. 16 shows a 5-nozzle embodiment of a cavitation device with nozzles 118A-118E arranged radially around crystal rod 119 located at the centerline. It is further envisioned to have any number of nozzles aligned radially around the centerline of the unit. Alternatively, in other embodiments, the shape of the nozzle may be any useful geometric shape, having any useful number of nozzles, which satisfies the desired goals and conditions.

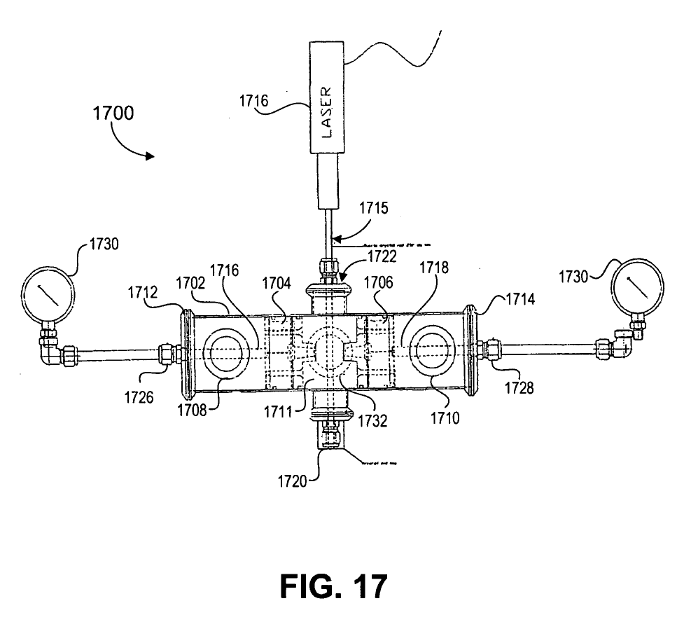

Another embodiment of a cavitation device is illustrated in FIG. 17. The device 1700 has a tubular housing 1702 which encloses a pair of nozzles 1704 & 1706. Housing 1702 is preferably formed from 316 stainless steel tubing or a similar corrosion resistant, inert material that is capable of withstanding the elevated operating pressures required for practicing the cavitation process. In the exemplary embodiment, housing 1702 has a diameter on the order of 60 to 80 mm (2.4 to 3.2 in.), although other dimensions may be selection for different applications. End caps 1712 and 1714 are attached to opposite ends of housing 1702 using a pressure-resistant seal. Liquids are introduced through inlet ports 1708 and 1710, where port 1708 supplies nozzle 1704 with liquid and port 1710 is the supply for nozzle 1706.

The liquid entering through the two inlet ports 1708 and 1710 is forced into the backside of the corresponding nozzle through a tangential channel and through the nozzle orifice into a cavitation chamber 1711. The nozzles 1704 and 1706 are oriented in an axially aligned, opposing relationship so that the liquid output from each nozzle will directly collide with the output from the other nozzle. This high energy collision results in generation of additional cavitational energy and mixing of the liquid. The liquid output from each nozzle with also collide with a crystal rod 1715 disposed at the center of the cavitation chamber 1711. The crystal rod 1715 may be composed of quartz crystal, or other material. Alternatively, other devices which introduce electrons into the fluid may be used in place of crystal rod. The inventors believe that the force of the liquid impinging against the crystal rod 1715, as well as the energy from the cavitation process may strip electrons off the crystal rod and into the fluid.

In this embodiment of the device 1700, a laser 1716 is provided to introduce laser light into the crystal rod 1715. It is known that come materials, such as a quartz crystal, will donate electrons when struck by a laser, so laser 1716, is optionally provided to increase the number of electrons that are introduced into the fluid. The wavelength and power of the laser 1716 may be chosen to optimize the number of electrons that it releases from the particular material chosen for the crystal rod 1715. The laser may be pulsed, for example, 2 ms pulses may be used.

Crystal rod 1715 may be covered with an aluminum wrap 1718 where it is not inside the cavitation chamber 1711 to avoid light transmission out of the crystal rod 1715. Light from the laser 1716 enters one end of the crystal rod 1715 and travels through the crystal rod until it is reflected by a mirror 1720 at the opposite end. The crystal rod 1715 is held in place by a mounting assembly 1722.

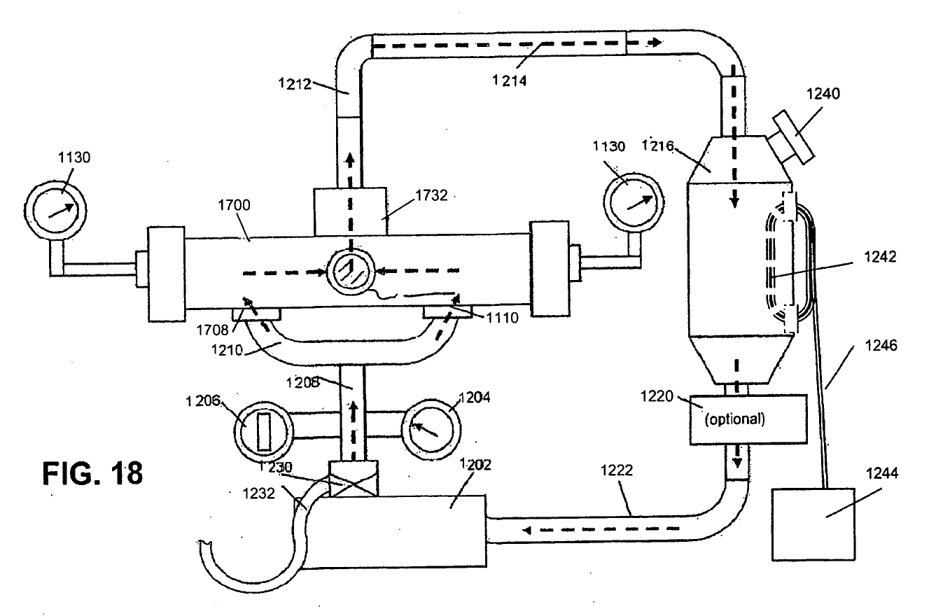

After passing out of the nozzles 1704, 1706 and into the cavitation chamber 1711, the liquid passes out of the device 1700 through discharge port 1732. A view port 1231 (shown in FIG. 18) may be provided in housing 1702 adjacent to the cavitation chamber 1711 to permit observation of the fluid during cavitation.

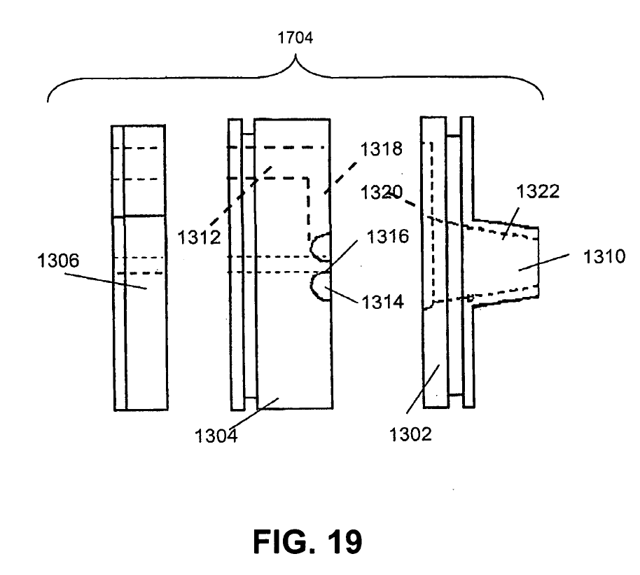

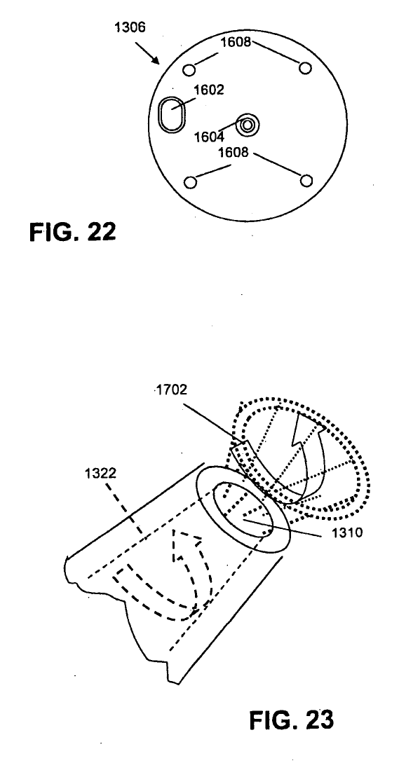

Details of the nozzle construction are illustrated in FIGS. 19-22. Nozzle 1704 is illustrated in FIG. 19. Nozzle 1706 is identical in construction to nozzle 1704 but it oriented within housing 1702 as a mirror image to nozzle 1704. Each nozzle includes three sections, the front section 1302, through which the liquids exit, the back section 1304, which combines with section 1302 to create the rotational vortex needed to induce cavitation, and vacuum plate 1306, which seals the entrance side of the nozzle within the housing interior so that all liquids are forced through the nozzle opening. In the preferred embodiment, the front and back sections are formed from Teflon® (polytetrafluoroethylene) and the vacuum plate 1306 is formed from 316 stainless steel.

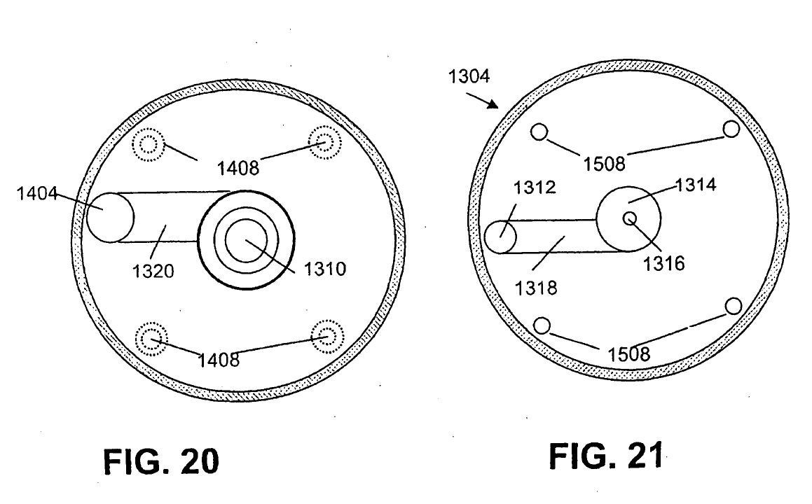

Front section 1302 includes a tapered cone that includes exit orifice 1310. FIG. 20 illustrates the inlet side of front section 1302, which, when assembled with back section 1304, shown in FIG. 21, provides a whirl chamber which is tangentially fed by the feed tube formed by combining recessed channels 1320 and 1318 of the front and back sections respectively. The whirl chamber is formed from the combination of circular channel 1314 and conical surface 1322, with raised center through which vacuum port 1316 extends to define a donut that ensures that the liquid is directed to the sidewalls of conical surface 1322 to generate the desired vortex.

Vacuum plate 1306 has an opening 1602 through which liquids enter the nozzle. Opening 1602 is aligned with input opening 1312 in back section 1304. Bores 1408, 1508 and 1608 are aligned to permit screws (not shown) to be inserted from the exit side of front section 1302 (where bores 1408 are countersunk) to be screwed into bores 1608, which are threaded to receive the screws.

Vacuum plate 1306 preferably has a compressible O-ring seal such as silicone or Viton® around its circumference to provide a tight seal between the edges of plate 1306 and the inner surface of housing 1702 while allowing the position of the nozzle to be moved axially within the housing. An additional aspect of the present invention relates to the ability to alter the distance between the nozzles 1704, 1706 as needed to achieve a desired interaction. The optimal distance may be specific to liquid viscosity and/or may relate to solid components of the liquid, such as in a suspension type system. The optimal distance may be further dictated by optimal treatment temperature per mixture/liquid to be treated. The optimal distance may further be correlated by atmospheric conditions. To provide for such needs, the nozzles of the present device are adjustably connected within the outer housing by means of steel tubes 1716, 1118 that are slidably inserted through the end caps 1712, 1714 of the housing 1702 and attached to the vacuum plates 1306 at center vacuum orifice 1604. The diameter of orifice 1604 may be about 1.6 mm ( 1/16 inches. This allows the distance between the nozzles 1704,1706 to be adjusted to a particular need, such as viscosity of the liquid to be processed. Once the desired separation between the nozzles is achieved, their positions may be fixed in place by tightening a Swagelock® 1726, 1728 or similar fastener attached to each end cap 1712, 1714. Appropriate fasteners and materials for providing the adjustable nozzle separation are known in the art. Vacuum gauges 1730 are connected to each tube 1716, 1718 to measure the vacuum produced at the rotational vortex within each nozzle through vacuum orifices 1604 and 1316. The vacuum orifices also provide means for introduction of liquids to be mixed by way of a cannula and an appropriate T-connection (not shown), which is generally known in the art.

As the liquid is forced through the rotational vortex, centripetal and centrifugal forces cause the water to take on laminar flow and to be forced against the outer portion of the tube through which the liquid is being forced. This combination of forces actually produces laminar flow liquid that is simultaneously rotating. However, this laminar flow liquid is different than the usual understanding of laminar flow fluids. The water flowing from a standard garden hose is one embodiment of well known laminar flow. However, in the garden hose type of laminar flow the water is of singular molecular motion, in the direction of exiting the hose. Moreover, the water from the garden hose will mimic the interior shape of the hose after exiting the house, until the flow energy is dissipated. However, in the present system, the liquid is forced into a rotational vortex in two dimensions, such that the molecules are rotating in the same rotational manner as the vortex through which the liquid was forced. Secondly, according to the pressure exerted by the liquid being forced around the radius of curvature and the resultant centripetal and centrifugal forces exerted on the molecules of the liquid, the molecules are coerced into a rotational motion simultaneous with being coerced into a laminar flow situation. However, unlike the garden hose example, because the liquid is being forced against the wall of the passage while being coerced into a rotational motion, when the liquid exits the nozzle and is released from the confining tube of the rotational vortex, the liquid forms a thin sheet of liquid.

FIG. 23 illustrates this process. In particular, FIG. 23 shows the effect that the whirl chamber and conical surface 1322 have on the output stream of liquid 1330. The liquid emitted from exit orifice 1310 has a hollow cone spray pattern that rotates in the same direction with which it was introduced into the whirl chamber. Each nozzle 1704 and 1706 emits the same spray pattern. For further maximizing the effect of the collision of the output streams, the cone spray patterns can rotate in opposite directions. The resulting outputs of the nozzles have rotational momentum and uniform outwardly radiating force, describing a parabola with the vertex at the exit point of the nozzle.

The interior diameter of the feed channel through which the liquid passes, as well as the diameter of the nozzle exit orifice may be altered in size to accommodate need and desired outcome.

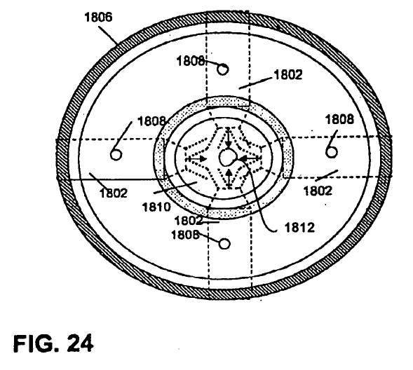

An alternate embodiment of the cavitation device is illustrated in FIG. 24. Four small inverted pump volutes (nozzles) 1802 made of Teflon® without impellers are housed in a 316 stainless steel pipe housing 1806. The volutes 1802 are tangentially fed through openings 1808 by a common liquid source within housing 1806. The common liquid source is fed by a 1V458 Gear pump at 65 psig through an opening 1808 that, although normally used as the discharge of a pump, is utilized as the input for the purpose of establishing a rotational vortex. The liquid entering the four volutes 1802 is directed in a 360 degree circle and discharged by the means of a 1″ long acceleration tube with a ⅜″ discharge hole. The discharge hole would normally be the suction side of a pump volute but, in this case, is utilized as the discharge side of the device. The four reverse fed volutes 1808 establish rotational vortexes that spin the liquid through one 360 degree rotation, then discharge the liquid down the four acceleration tubes, each of which provides a 6 degree decreasing angle (as measured from the center line of the tube) acceleration section. The accelerated liquid is discharged into a common chamber 1810 at or close to atmospheric pressure. A crystal rod 1812 is disposed in the common chamber 1810 to increase the number of free electrons in the fluid. The common chamber 1810 is connected to a stainless steel discharge line that feeds back into the top of a tank containing the liquid. At this point, the liquid has made one treatment pass through the device. The process described above nay be repeated continuously until the energy created by the implosions and explosions of the cavitation (e.g., due to the acoustical energy) have imparted sufficient kinetic heat to the liquid to raise the temperature to a desired level or until a specified processing period has expired. For water, the threshold temperature is about 60° C.

The same or a similar process whereby the liquid or liquids is/are subjected to one or more rotational vortices starting under reduced pressure and experiencing pressure gradients such that cavitation bubbles are formed and implode and explode through the process, are referred to herein as “physics device”, and/or “physics process”, and/or “vortexing device”, and or “cavitation device”, and/or “cavitating process” and/or “fractionating device”.

An exemplary system for processing a fluid with cavitation is illustrated in FIG. 18. Liquid to be processed is introduced into the process loop through inlet port 1240 in tank 1216 and is pumped into cavitation device 1700 by pump 1202 through a 316 stainless steel line 1208 to a Y-connection 210 which distributes the liquid to the two inlet ports 1708, 1710 of device 1700. Alternatively, liquid or a component to be mixed into the liquid may be introduced through a cannula connected to the vacuum port 1604 of one of the vacuum plates 1306. The liquid is pumped into cavitation device 1700 at a pressure such that rotational vortices are produced in each nozzle. The pressure will depend upon the type and viscosity of the liquid to be processed and the nozzle orifice sizes, but the pressure generally falls within the range of 55 to 150 psig. In this example the pressure for processing water may be about 65 psig. After subjecting the liquid to the cavitation process, it leaves the device through discharge port 1732 and is directed through stainless steel lines 1212 and 1214 into stainless steel tank 1216. The liquid continues from tank 1216 through stainless steel line 1222 back to pump 1202 for recirculating through the cavitation device for as many iterations as needed until the desired termination point is achieved. Pressure gauge 1204 measures the output pressure from pump 1202 and digital temperature readout 1206 displays the temperature of the liquid as it enters the cavitation to device 1700.

During processing of fluid, such as water, as described above, the thermo-physical reactions that occur during the cavitation process cause the water temperature to increase. The temperature is permitted to rise and processing is deemed completed when the water temperature reaches a specified temperature. However, in certain processes, it may be desirable to control the rate of temperature increase in the fluid to maximize mixing time without allowing the fluid to become excessively heated. As illustrated, an optional temperature regulation unit 1220, such as a heat exchanger, cooling jacket, or other cooling means as are known in the art, can be incorporated into the processing loop. While the temperature regulation unit 1220 is illustrated downstream from the tank 1216, it may be placed at other positions within the loop to achieve the same result. In another embodiment, a cooling jacket may be placed around tank 1216.

In a preferred embodiment, temperature regulation is provided by cooling coils 1242 that enter tank 1216 through liquid tight ports in its base or sidewall. The coils 1242 should be positioned to avoid interference with the flow of liquid into and out of the tank. The coils are connected to a recirculating cooling bath 1244 by tubing 1246. Water or other coolant such as ethylene glycol is circulated though coils 1242, the outer surfaces of which come into direct contact with the liquid within tank 1216 to draw heat away from the liquid to provide temperature regulation. In the preferred embodiment, the coils 1242 and tubing 1246 are ½″ copper tubing, which provides a significant advantage since the copper serves as a natural preservative. To enhance the preservative effect, a preferred process includes the addition of a small (catalytic) amount of ascorbic acid into the liquid being processed. The result of the reaction between the ascorbic acid and the copper is a neutral chelate that is naturally anti-fungal, anti-microbial, anti-viral and anti-inflammatory, such that these properties are imparted to the mixture that is being processed. As is known in the art, to provide the desired preservative effect, coils 1242 may be formed from other metals that will form neutral chelates in the presence of an appropriate catalyst that is safe for inclusion in the fluid. Other metals include, but are not limited to silver, gold, zinc, platinum, tungsten, palladium, etc.

Once the desired processing has been completed, as determined either by time or by reaching a specified temperature threshold, valve 1230 is opened to direct the processed liquid out of the loop through tubing 1232 and into an appropriate storage vessel or other container(s) (not shown). While tubing 1232 is illustrated as flexible tubing, it will be readily apparent that rigid tubing, such as the stainless steel line used elsewhere in the loop, may be used to provide a connection between the valve and a reservoir or tank through which liquid may be discharged from the loop.

In other embodiments of the invention, other techniques may be employed to increase the number of free electrons in the micro-luster water besides those discussed above. For example a device that applies pressure to the crystal rod may be employed. The pressure inducing device may be similar to a vise that squeezes the crystal along its length, its width, or both. This mechanical pressure may increase the number of electrons emitted by the crystal.

Water prepared by the cavitation methods of the invention without the addition of extra electrons using, for example the crystal rod, was characterized with respect to various parameters. Conductivity was tested using the USP 645 procedure that specifies conductivity measurements as criteria for characterizing water. In addition to defining the test protocol, USP 645 sets performance standards for the conductivity measurement system, as well as validation and calibration requirements for the meter and conductivity. Conductivity testing was performed by West Coast Analytical Service, Inc. in Santa Fe Springs, Calif.

Test results are shown in the following table:

| | | Micro-cluster | Micro-cluster |
|---|---|---|---|
| | RO Water | water | water with O₂ |
| Conductivity at | 5.55 | 3.16 | 3.88 |
| 25° C. | | | |
| (μmhos/cm) | | | |

Conductivity values above are the average of two measurements. The conductivity observed for the micro-cluster water is reduced by slightly more than half compared to the RO water. This is highly significant and indicates that the micro-cluster water exhibits significantly different behavior and is therefore substantively different, relative to RO unprocessed water.

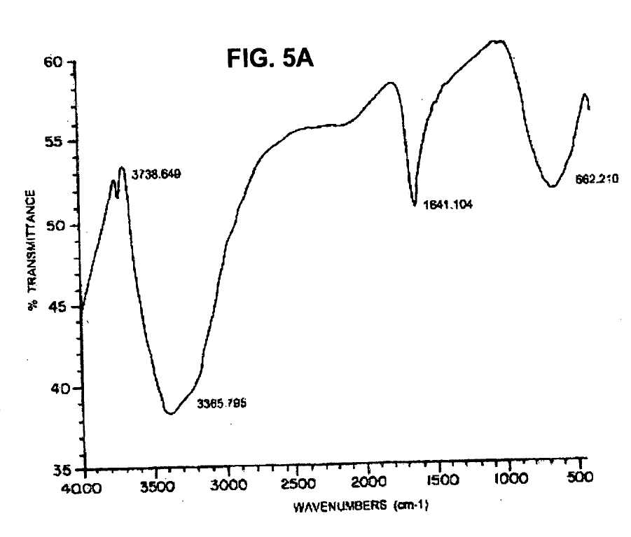

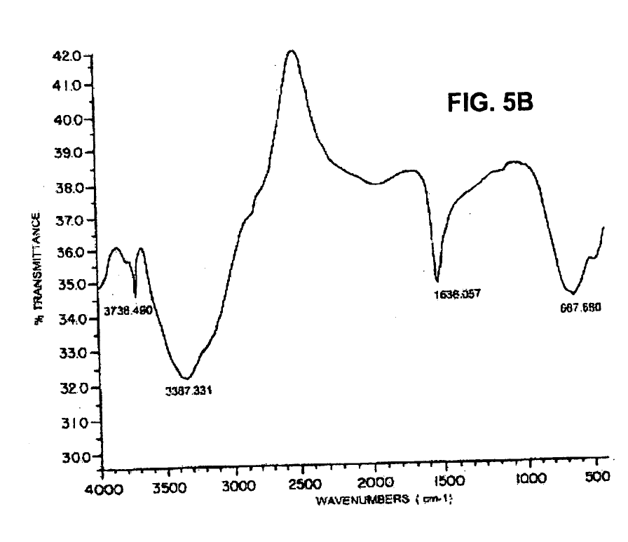

Fourier Transform Infra Red Spectroscopy (FTIR) was also performed. Water, a strong absorber in the IR spectral region, has been well-characterized by FTIR and shows a major spectral line at approximately 3000 wave numbers corresponding to O—H bond vibrations. This spectral line is characteristic of the hydrogen bonding structure in the sample. An unprocessed RO water sample, Sample A, and a un-oxygenated micro-cluster water sample, Sample B, were each placed between silver chloride plates, and the film of each liquid analyzed by FTIR at 25° C. The FTIR tests were performed by West Coast Analytical Service, Inc. in Santa Fe Springs, Calif. using a Nicolet Impact 400D™ bench top FTIR. The FTIR spectra are shown in FIG. 5.

In comparing the FTIR spectra for the un-oxygenated micro-cluster and RO waters, it is clear that the two samples have a number of features in common, but also significant differences. A major sharp feature at approximately 2650 wave numbers in the FTIR spectrum is observed for the micro-cluster water (FIG. 5(b)). The RO water has no such feature (FIG. 5(a)). This indicates that the bonds in the water sample are behaving differently and that their energetic interaction has changed. These results suggest that the un-oxygenated micro-cluster water is physically and chemically different than RO unprocessed water.

Simulated distillations were carried out on RO water and un-oxygenated micro-cluster water without oxygenation by West Coast Analytical Service, Inc. in Santa Fe Springs, Calif. Results of a simulated distillation is shown in the following table:

| | | Un-oxygenated |
|---|---|---|
| | RO Water | Micro-cluster water |
| Boiling point | 98-100 | 93.2-100 |
| range (deg. C.) | | |

These results, which have been corrected for barometric pressure, show a significant lowering of the boiling temperature of the lowest boiling fraction in the un-oxygenated micro-cluster water sample. The lowest boiling fraction for micro-cluster water is observed at 93.2 degree C. compared with a temperature of 98 degree C. for the lowest boiling fraction of RO water. This suggests that the process has significantly changed the compositional make-up of molecular species present in the sample. Note that lower boiling species are typically smaller, which is consistent with all observed data and the formation of micro-clusters.

Thermogravimetric analysis was also performed on micro-cluster water. In this test, one drop of water was placed in a differential scanning calorimetry (dsc) sample pan and sealed with a cover in which a pin-hole was precision laser-drilled. The sample was subject to a temperature ramp increase of 5 degrees every 5 minutes until the final temperature. TGA profiles were run on both un-oxygenated micro-cluster water and RO water for comparison.

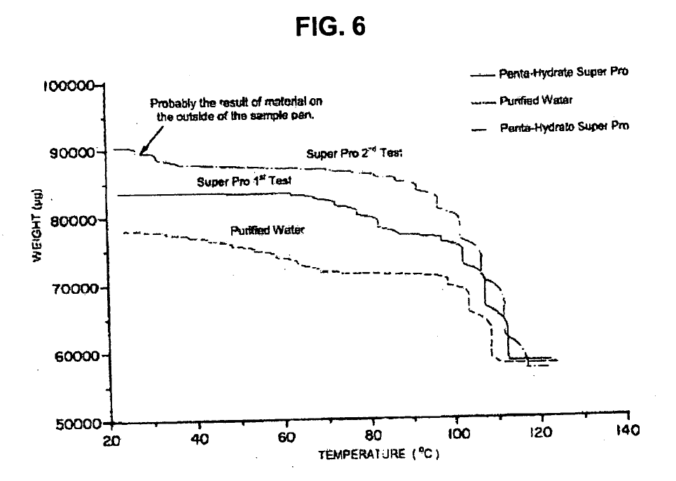

The TGA analysis was performed on a TA Instruments Model TFA2950™ by Analytical Products in La Canada, Calif. The TGA test results are shown in FIG. 6. Three test runs utilizing three different samples are shown. The RO water sample is designated, “Purified Water” on the TGA plot. The un-oxygenated micro-cluster water was run in duplicate, designated Super Pro 1^{st} test and Super Pro 2^{nd} Test. The un-oxygenated micro-cluster water and the unprocessed RO water showed significantly greater weight loss dynamics. It is evident that the RO water began losing mass almost immediately, beginning at about 40 degrees C. until the end temperature. The micro-cluster water did not begin to lose mass until about 70 degrees C. This suggests that the processed water has a greater vapor pressure between 40 and 70 degrees C. compared to unprocessed RO water.

The TGA results demonstrated that the vapor pressure of the oxygenated micro-cluster water was lower when the boiling temperature was reached. These data once again show that the un-oxygenated micro-cluster water is significantly changed compared to RO water. These data once again show that the un-oxygenated micro-cluster water also shows more features between the temperatures of 75 and 100+ degrees C. These features could account for the low boiling fraction(s) observed in the simulated distillation.

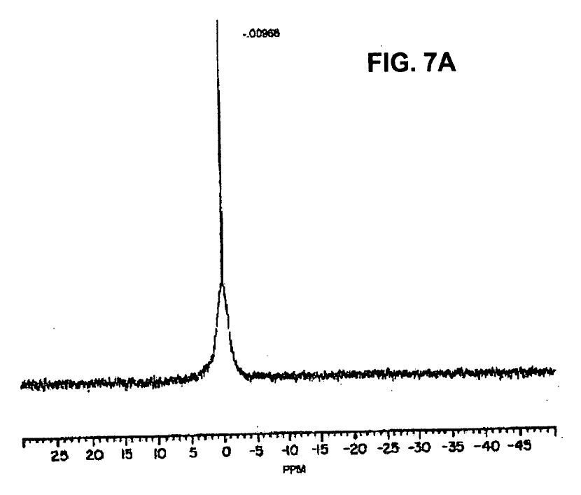

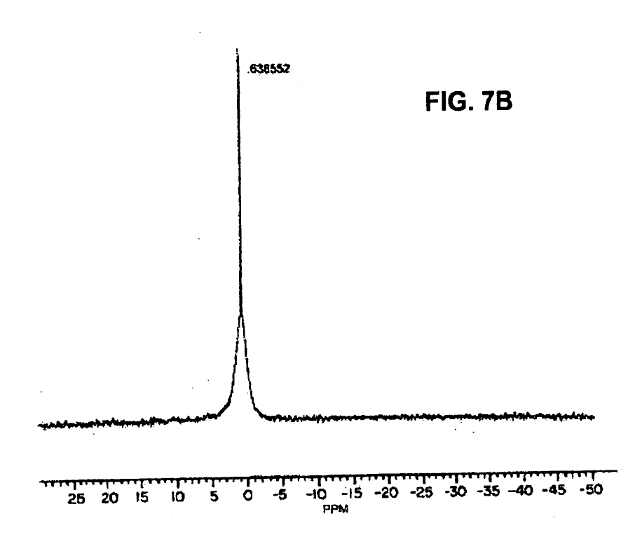

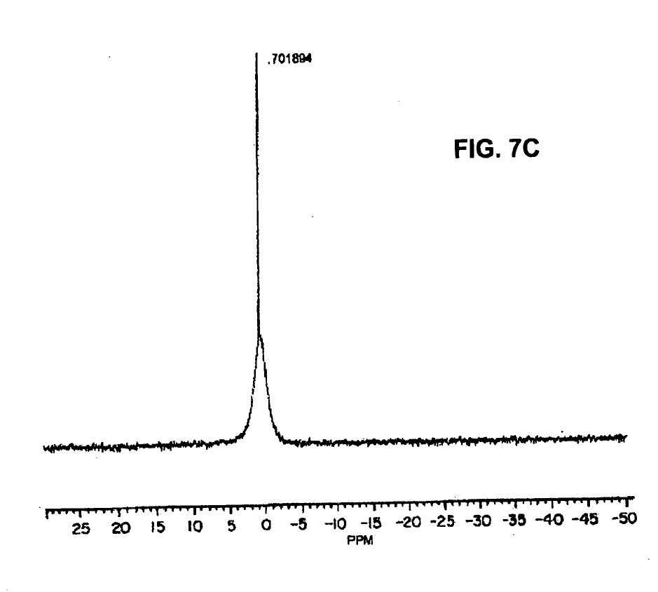

Nuclear Magnetic Resonance (NMR) Spectroscopy testing was performed by Expert Chemical Analysis, Inc. in San Diego, Calif. utilizing a 600 MHz Bruker AM500™ instrument. NMR studies were performed on micro-cluster water with and without oxygen and on RO water. The results of these studies are shown in FIG. 7. In ¹⁷O NMR testing a single expected peak was observed for RO water (FIG. 7(a)). For micro-cluster water without oxygen (FIG. 7(b)), the single peak observed was shifted +54.1 Hertz relative to the RO water, and for the micro-cluster water with oxygen (FIG. 7(c)), the single peak was shifted +49.8 Hertz relative to the RO water. The shifts of the observed NMR peaks for the micro-cluster water and RO water. Also of significance in the NMR data is the broadening of the peak observed with the micro-cluster water sample compared to the narrower peak of the unprocessed sample.

Raman spectroscopy, which is highly sensitive to structural modification of liquids, was employed to characterize and differentiate micro-cluster structures and micro-clustered molecular structure liquids. This study was based on obtaining and processing spontaneous Raman spectra and allowing a registration of types of phase transition in liquid water at 4, 19, 36 and 75 degrees Celsius. The hydrogen bond network and the average per unit volume hydrogen bond concentration were determined, which led to characterization of waters produced by different methods and in particular differentiation and definition of water composition produced by the methods described above for making micro-clusters.

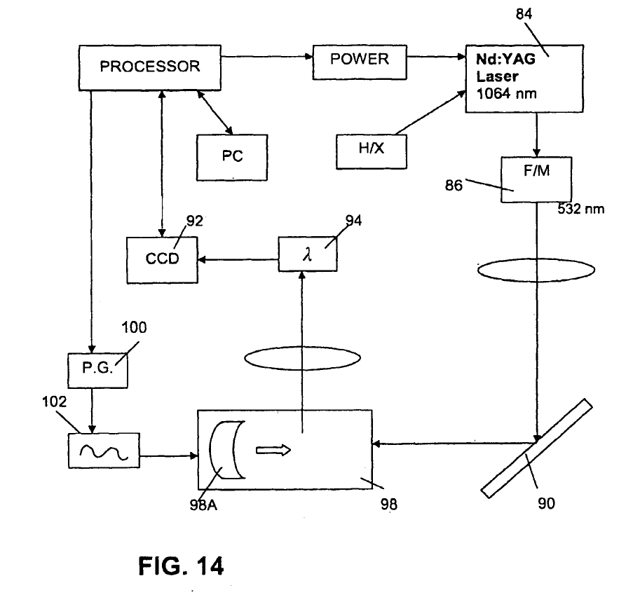

FIG. 14 schematically illustrates the device used in these studies. The source of illumination was a Q-switched solid state Nd:YAG laser (Spectra Physics Corp., Mountain View, Calif.) with two harmonics output at 1064 nm and its doubled frequency to produce a wavelength of 532 nm. A second harmonic generator comprised a KTP crystal available from Kigre, Tuscon, Ariz. The first harmonic was at 1064 nm with a pulse energy of 200 mJ, width of 10 ns, and repetition rate of 6 Hz. The optical mirror and translucent cell were obtained from CVC Optics, Albuquerque, N. Mex. The spectrometer was obtained from Hamamatsu (Japan), and its auto-collimation system from Newport Corporation, Costa Mesa, Calif. The electro-optical converter was from Texas Instruments, Houston, Tex.

The cell was filled with water as a test subject. The following water samples were studied: oxygenated micro-cluster water, un-oxygenated micro-cluster water, Millipore™ distilled water, distilled water prepared in the laboratory, medical-grade double distilled injection water, bottled commercial reverse osmosis water, and tap water (unprocessed). The test water was subjected to strong ultrasonic fields produced by a pulse generator and a sine wave generator and a focusing horn. A laser beam was directed into a cell. Signals scattered at 90 degrees entered the spectrometer, which contained a grating unit providing a dispersion of 2 nm/mm. A Raman scattering spectrum was measured by a detector.

The results indicated the modifications in micro-cluster water of the local structure of the hydrogen-bond net in the acoustic field. In particular, the modification corresponded to a local decrease of the average distance between oxygen atoms to 2.80 angstroms, enhancing the ordering of the net structure of hydrogen-bonded water molecules to nearly that of hexagonal ice, where this distance is 2.76 angstroms.

The test samples which contained micro-cluster water were shown to have about a ten degree Celsius higher cluster temperature compared to the other water samples, which indicated that the average cluster size was smaller in the micro-cluster waters than in the other water samples. Further, the micro-cluster waters represented a more homogeneous composition of cluster sizes than the other waters, i.e. a more homogenous molecular cluster structure.

As noted above, the above tests were performed on micro-cluster water without having electrons added using, for example, the crystal rod.

Those skilled in the art to which this invention pertains will understand that the foregoing description of the details of preferred embodiments is not to be construed in any manner as to limit the invention. Such readers will understand that other embodiments may be made which fall within the scope of the invention, which is defined by the following claims and their legal equivalents.

We claim:

1. A process for modifying a liquid, comprising:
introducing a liquid into a cavitation device;
cavitating said liquid in said cavitation device; and
causing said liquid to make contact with an electron emitting material during said cavitating.

2. The process of claim 1 wherein said liquid is water.

3. The process of claim 1 wherein said electron emitting material is a crystal.

4. The process of claim 3 wherein said crystal is a quartz crystal.

5. The process of claim 1 wherein said electron emitting material is a semiconductor material.

6. The process of claim 1 further comprising a light emitting device, which directs a beam of light into said electron emitting material, wherein said light increases the number of electrons emitted by said electron emitting material during said cavitating.

7. The process of claim 1 wherein said cavitating further comprises:
subjecting said liquid to a pressure sufficient to pressurize said liquid;
emitting pressurized liquid such that a continuous stream of liquid is created;
subjecting said continuous stream to a rotational vortex to form a plurality of cavitation bubbles; and
subjecting said liquid containing said cavitation bubbles to a reduced pressure, thereby producing a micro-cluster liquid.

8. The process of claim 1 wherein said cavitating further comprises using an ultrasonic transducer to cavitate said liquid.

9. A method for producing a micro-clustered liquid comprising:
cavitating a liquid; and
adding electrons to said liquid during said cavitation.

10. The method of claim 9 wherein said liquid is water.

11. The method of claim 9 wherein said adding electrons further comprises directing said liquid onto a material when said liquid is cavitating, said material releasing electrons when in contact with said cavitating liquid.

12. The method of claim 11 wherein said cavitating a liquid comprises introducing said liquid into a cavitation chamber having said material inside.

13. The method of claim 12 further comprising removing said liquid from said cavitation chamber and bottling said liquid.

14. An apparatus for processing a liquid comprising:
a cavitation device having a cavitation chamber; and
an electron emitting component within said cavitation chamber.

15. The apparatus of claim 14 wherein said cavitation device comprises a plurality of nozzles disposed within said cavitation chamber, wherein a fluid passing through said nozzles generates cavitation bubbles within said liquid such that collapse of said bubbles produces shock waves that produce localized heat and pressure to induce the removal of electrons from said electron emitting component within said chamber.

16. The apparatus of claim 14 wherein said liquid is water.

17. The apparatus of claim 14 wherein said electron emitting component includes an ultrasound transducer.

18. The apparatus of claim 14 wherein said electron emitting component includes a crystal.

19. The apparatus of claim 18 wherein said electron emitting component includes a laser directing light into said crystal.

20. The apparatus of claim 14 wherein said electron emitting component is a pressure inducing device.

21. Micro-cluster liquid produced by the process of claim 1 or claim 9.

22. An article of manufacture comprising the micro-cluster liquid of claim 21.

23. A method for lowering free radical levels in a cell comprising contacting a cell with a micro-cluster water made by the process of claim 1 or claim 9.

24. A system for producing a micro-cluster liquid from a starting liquid comprising:
a housing;
a chamber disposed within said housing;
an electron emitting element disposed within said chamber; and
a plurality of volutes disposed within said housing for receiving a liquid and establishing a rotational vortex for spinning said liquid and directing said liquid radially onto said electron emitting element.

25. The system of claim 24 wherein said rotational vortex creates cavitation bubbles when said liquid exits said volutes and wherein said chamber has a lower pressure than said liquid in said volute such that said cavitation bubbles explode or implode within said chamber against said electron emitting element.
